(19) United States
(12) Patent Application Publication
(10) Pub. No.: US 2018/0007465 A1
(43) Pub. Date: Jan. 4, 2018

(54) SPEAKER HAVING EXTENDED LOW FREQUENCY AND ELECTRONIC DEVICE USING THE SAME

(71) Applicant: Acer Incorporated, New Taipei City (TW)

(72) Inventors: Feng-Ming Liu, New Taipei City (TW); Jia-Ren Chang, New Taipei City (TW)

(21) Appl. No.: 15/635,285

(22) Filed: Jun. 28, 2017

(30) Foreign Application Priority Data
Jun. 29, 2016 (TW) 105120533
Dec. 6, 2016 (TW) 105218622

(51) Int. Cl. H04R 1/28; H04R 1/02

(52) U.S. Cl. CPC H04R 1/2819; H04R 1/2865; H04R 1/025; H04R 1/2857; H04R 2499/11

(57) ABSTRACT

A speaker having extended low frequency and an electronic device using the same are provided. The speaker includes a first sound box, a horn, a second sound box and a sound tube. The horn is disposed in the first sound box. The horn faces the second sound box. The sound tube is connected to the second sound box.

This application claims the benefit of Taiwan application Serial No. 105120533, filed Jun. 29, 2016 and Taiwan application Serial No. 105218622, filed Dec. 6, 2016, the subject matters of which are incorporated herein by references.

### BACKGROUND OF THE INVENTION

### Field of the Invention

The invention relates in general to a speaker and an electronic device using the same, and more particularly to a speaker having extended low frequency and an electronic device using the same.

### Description of the Related Art

Along with the advance in technology, various electronic devices are provided one after another. Many portable electronic devices are equipped with a speaker for playing music or generating sound. In response to users' requirement of the portability of electronic devices, the development of electronic devices is directed towards the thinning design, and the interior of the speaker also needs to be thinned.

However, as the development of speakers is directed towards the thinning deign, the low frequency of the sound is greatly declined. After all kinds of trials, the sound at most can reach the frequency up to 600 Hz and cannot reach the frequency below 600 Hz. Therefore, the users' audio enjoyment cannot be satisfied.

### SUMMARY OF THE INVENTION

The invention is directed to a speaker having extended low frequency and an electronic device using the same. When a first sound box, a second sound box and a sound tube are equipped with a thinned or miniaturized horn, the sound still can have very good performance when the frequency ranges from 600 Hz to 250 Hz. Therefore, the low frequency of the sound can be extended to 250 Hz to satisfy the users' audio enjoyment.

According to one embodiment of the present invention, a speaker is provided. The speaker includes a first sound box, a horn, a second sound box and a sound tube. The horn is disposed in the first sound box. The horn faces the second sound box. The sound tube is connected to the second sound box.

According to another embodiment of the present invention, an electronic device is provided. The electronic device includes a speaker and a sound processing circuit. The speaker includes a first sound box, a horn, a second sound box and a sound tube. The horn is disposed in the first sound box. The horn faces the second sound box. The sound tube is connected to the second sound box. The sound processing circuit generates a sound signal to the speaker.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an electronic device according to an embodiment.

FIG. 2 is an external view of a speaker.

FIG. 3 a schematic diagram of the internal space of the speaker of FIG. 2.

FIG. 4 is a side view of the speaker of FIG. 2.

FIG. 5 is a schematic diagram of a frequency curve.

FIG. 6 is a schematic diagram of a speaker according to another embodiment.

FIG. 7 is a schematic diagram of a speaker according to another embodiment.

FIG. 8 is an external view of a speaker according to another embodiment.

FIG. 9 is a schematic diagram of the internal space of the speaker of FIG. 8.

FIG. 10 is a side view of the speaker of FIG. 8.

FIG. 11 is a schematic diagram of a speaker according to another embodiment.

FIG. 12 is a schematic diagram of a speaker according to another embodiment.

FIG. 13 is a schematic diagram of a speaker according to another embodiment.

FIG. 14 is a schematic diagram of a speaker according to another embodiment.

### DETAILED DESCRIPTION OF THE INVENTION

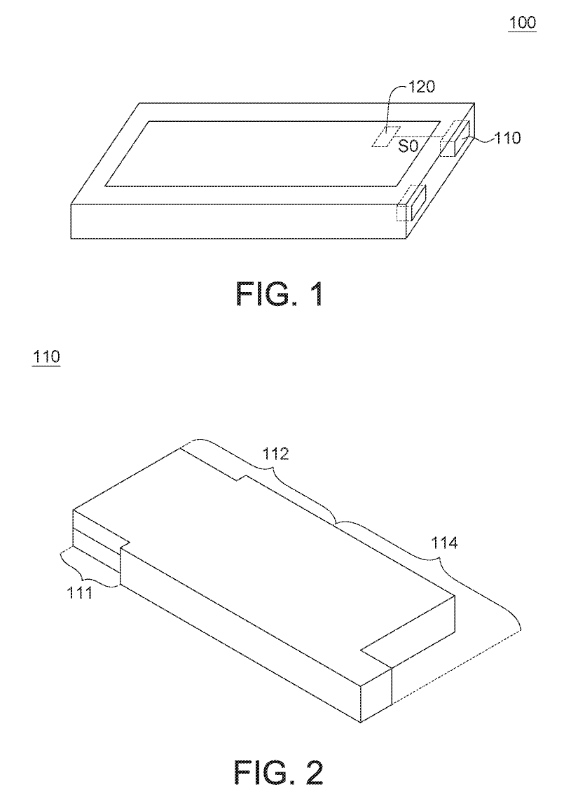

Referring to FIG. 1, a schematic diagram of an electronic device 100 according to an embodiment is shown. The electronic device 100 is such as a tablet, a laptop, a smartphone, or a handheld audio and video device. The electronic device 100 includes a speaker 110 and a sound processing circuit 120. The sound processing circuit 120 is for providing a sound signal S0 to the speaker 110. In response to the users' requirement of the portability of the electronic device 100, the development of the electronic device 100 is directed the thinning design, and the interior of the speaker 110 also needs to be thinned or miniaturized.

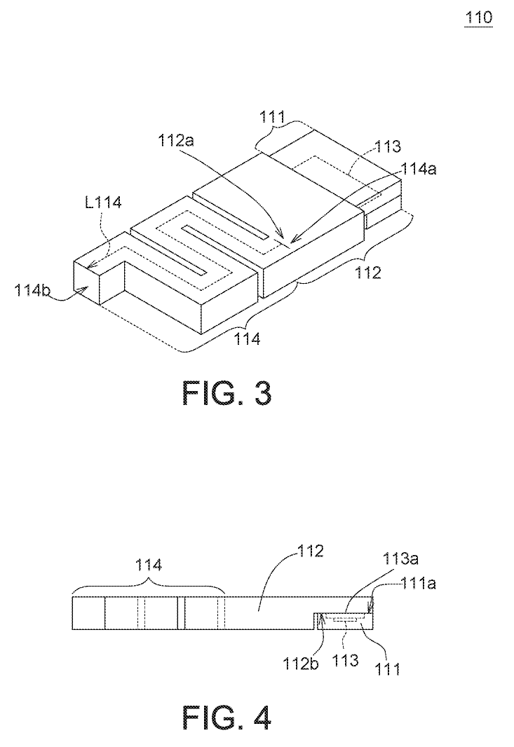

Refer to FIGS. 2 to 4. FIG. 2 is an external view of a speaker 110. FIG. 3 is a schematic diagram of the internal space of the speaker 110 of FIG. 2. FIG. 4 is a side view of the speaker 110 of FIG. 2. The speaker 110 includes a first sound box 111, a horn 113, a second sound box 112 and a sound tube 114. In response to the thinning requirement of the speaker 110, a length of the horn 113 ranges from 1.5 cm to 2.6 cm, a width of the horn 113 ranges from 0.8 cm to 1.1 cm, and a thickness of the horn 113 ranges from 0.2 cm to 0.4 cm. In an embodiment, the length, the width and the thickness of the horn 113 are equivalent to 1.6 cm, 0.9 cm and 0.3 cm, respectively.

As indicated in FIG. 4, the first sound box 111 is a hermetic sound box. A volume of the first sound box 111 ranges from 0.8 cm³ to 1.2 cm³, such as 1 cm³. The horn 113 is disposed in the first sound box 111. A vibration film 113a of the horn 113 is disposed in the outer surface 111a of the first sound box 111. The horn 113 resonates through the first sound box 111 to expand the range of the frequency of the sound. However, the horn 113 is small in size. The low frequency of the sound generated by the horn 113 can only reach 600 Hz even with the resonation of the first sound box 111, and the frequency of the sound cannot be below 600 Hz.

As indicated in FIG. 3, the horn 113 faces the second sound box 112. The sound tube 114 is connected to an opening 112a of the second sound box 112. The second sound box 112 is an open sound box. The volume of the second sound box 112 is greater than that of the first sound box 111. Experiments show that when the ratio of the volume of the second sound box 112 to that of the first sound box 111 is greater than 3.75, the low frequency of the sound will be below 600 Hz. As indicated in FIG. 4, the horn 113 is disposed at the connection between the first sound box 111 and the second sound box 112. A vibration film 113a of the horn 113 is disposed on an inner surface 112b of the second sound box 112.

Based on the Helmholtz principle, the second sound box 112 and the sound tube 114 can effectively expand the low frequency of the sound to a lower range of audio frequency. Referring to formula (1). The structural design of the second sound box 112 and the sound tube 114 is based on formula (1):

$$f = \frac{{V}_{s}}{2 π} \sqrt{\frac{A}{VL}} \qquad ( 1 )$$

Wherein f denotes the frequency, Vₛ denotes the propagation rate of sound waves, π denotes the circular constant, A denotes the cross-sectional area of the sound tube 114, V denotes the volume of the second sound box 112, and L denotes the length of the sound tube 114 (such as the length L114 of FIG. 3).

That is, for the speaker 110 to provide a low frequency sound wave whose frequency is lower than 600 Hz, the length of the sound tube 114 is designed to be negatively correlated with the frequency of the low frequency sound wave, the cross-sectional area of the sound tube 114 is designed to be positively correlated with the low frequency sound wave, and the volume of the second sound box 112 is designed to be negatively correlated with the frequency of the low frequency sound wave.

In other words, to provide a target frequency of the low frequency sound wave, the length of the sound tube 114, the cross-sectional area of the sound tube 114 and the volume of the second sound box 112 can be determined according to formula (2):

$$\frac{A}{VL} = \frac{{f}^{2} {v}_{s}^{2}}{4 {π}^{2}} \qquad ( 2 )$$

The length of the sound tube 114 can be determined according to formula (3):

$$L = \frac{4 {π}^{2} A}{{f}^{2} {v}_{s}^{2} V} \qquad ( 3 )$$

The cross-sectional area of the sound tube 114 and the volume of the second sound box 112 can be determined according to formula (4):

$$A = \frac{{f}^{2} {v}_{s}^{2} VL}{4 {π}^{2}} \qquad ( 4 )$$

The volume of the second sound box 112 can be determined according to formula (5):

$$V = \frac{4 {π}^{2} A}{{f}^{2} {v}_{s}^{2} L} \qquad ( 5 )$$

For example, the volume of the second sound box 112 can be designed to be ranged from 8 cm³ to 9 cm³, the length of the sound tube 114 can be designed to be ranged from 11 cm to 13 cm, and the cross-sectional area of the sound tube 114 can be designed to be ranged from 0.2 cm² to 0.4 cm². In an embodiment, the volume of the second sound box 112 can be designed to be 8.9 cm³, the length of the sound tube 114 can be designed to be 1.242 cm, and the length and the width of the cross-sectional area of the sound tube 114 can be designed to be 0.59 cm and 0.6 cm, respectively.

In an embodiment, the sound tube 114 can adopt a uniform cross-sectional area to generate a better output effect of sound waves. As indicated in FIG. 3, from the entrance 114a of the sound tube 114 to the exist 114b of the sound tube 114, the cross-sectional area of the sound tube 114 is substantially identical.

In an embodiment as indicated in FIG. 3, to avoid the speaker 110 occupying too much space, the sound tube 114 can be designed to have a curved S shape through the use of several partition plates. Or, the sound tube 114 can be designed to have a U shape.

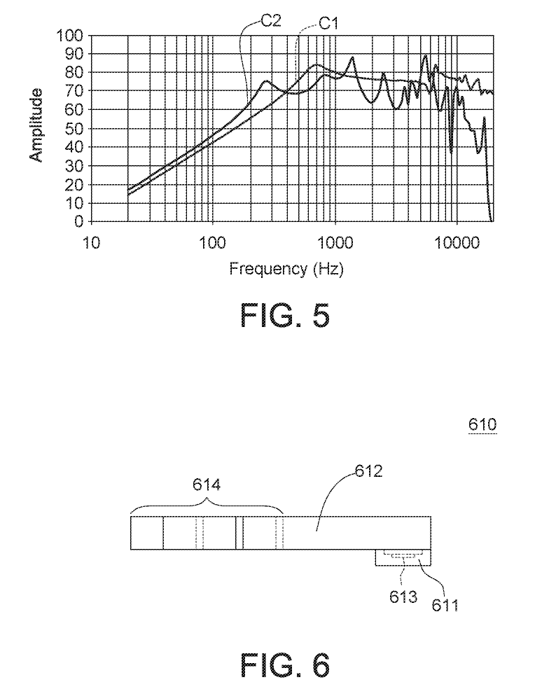

Referring to FIG. 5, frequency curves C1 and C2 are shown. The frequency curve C1 is a curve obtained when the horn 113 performs resonation by using only one single sound box. The frequency curve C2 is a curve obtained when the horn 113 performs resonation by using the first sound box 111 and performs sound guiding by using the second sound box 112 and the sound tube 114. As indicated in the frequency curve C1, the low frequency sound can reach 600 Hz and cannot reach the frequency below 600 Hz. As indicated in the frequency curve C2, the low frequency sound still has very good performance when the frequency ranges from 600 Hz to 250 Hz. Therefore, the frequency of the sound can extend to 250 Hz to satisfy the users' audio enjoyment.

Referring to FIG. 6, a schematic diagram of a speaker 610 according to another embodiment is shown. In the present embodiment, the horn 613 and the sound tube 614 of the speaker 610 are similar to the horn 113 and the sound tube 114 of FIG. 4, and the similarities are not repeated here. The second sound box 612 is a cuboid and the first sound box 611 is protruded outside the second sound box 612 for the convenience of the manufacturing of the second sound box 612. Experiments show that the implementation of the present embodiment can also generate a low frequency sound whose frequency is extended.

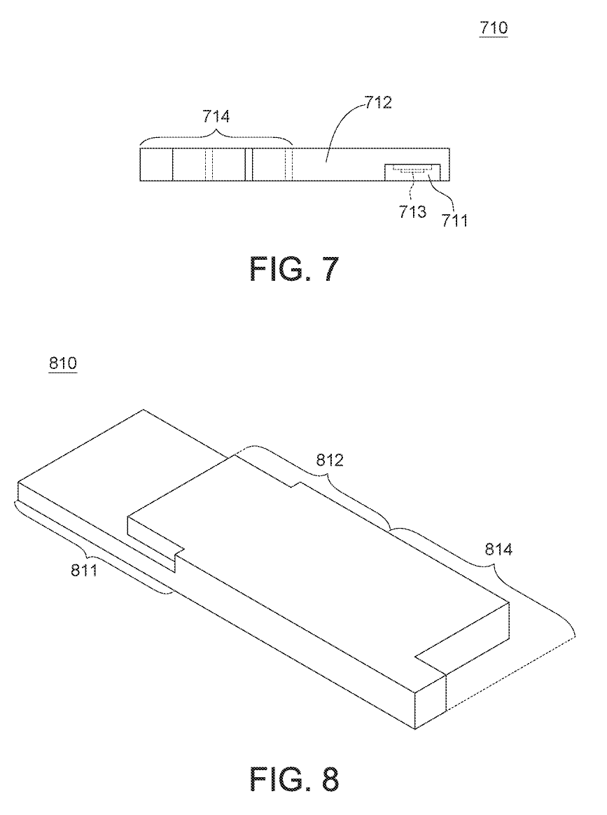

Referring to FIG. 7, a schematic diagram of a speaker 710 according to another embodiment is shown. In the present embodiment, the horn 713 and the sound tube 714 of the speaker 710 are similar to the horn 113 and the sound tube 114 of FIG. 4, and the similarities are not repeated here. The first sound box 711 is embedded inside the second sound box 712. Experiments show that the implementation of the present embodiment can also generate a low frequency sound whose frequency is extended.

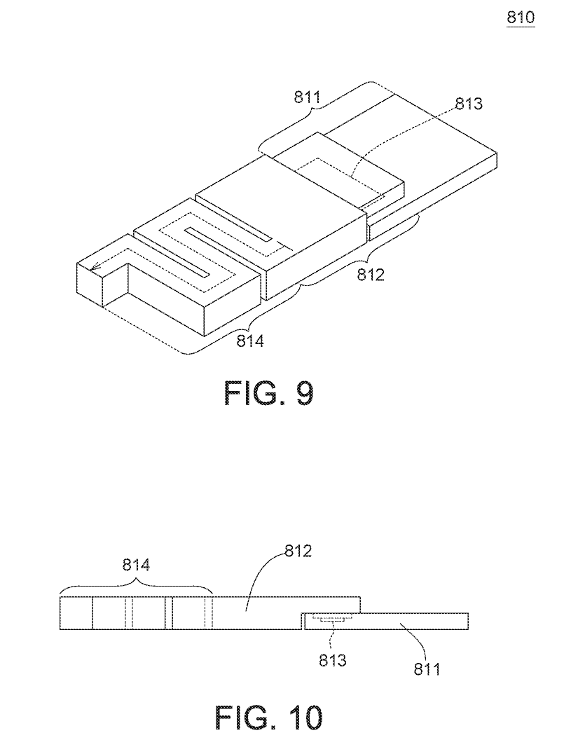

Refer to FIGS. 8 to 10. FIG. 8 is an external view of a speaker 810 according to another embodiment. FIG. 9 is a schematic diagram of the internal space of the speaker 810 of FIG. 8. FIG. 10 is a side view of the speaker 810 of FIG. 8. In the present embodiment, the second sound box 812, the horn 813, the sound tube 814 of the speaker 810 are similar to the second sound box 112, the horn 113, and the sound tube 114 of FIG. 4, and the similarities are not repeated here. The first sound box 811 extends backwards. Experiments show that the implementation of the present embodiment can also generate a low frequency sound whose frequency is extended.

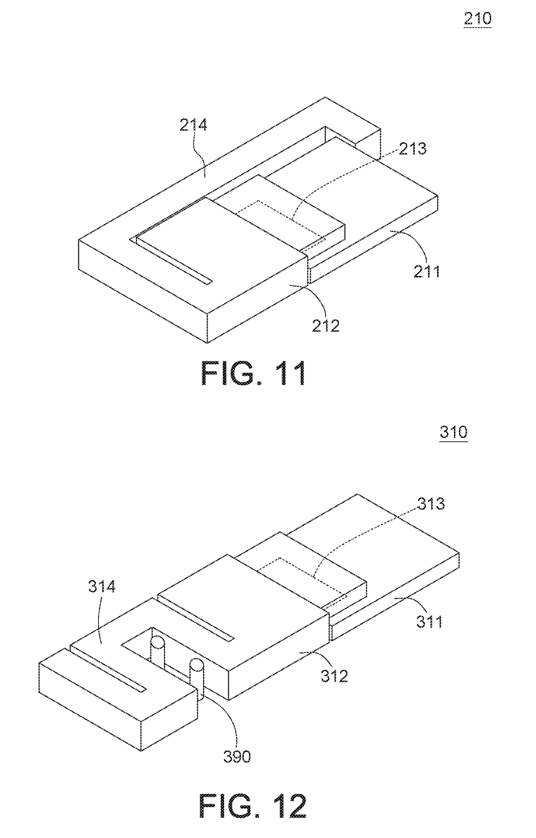

Referring to FIG. 11, a schematic diagram of a speaker 210 according to another embodiment is shown. In the present embodiment, the first sound box 211, the second sound box 212 and the horn 213 of the speaker 210 are similar to the first sound box 111, the second sound box 112 and the horn 113 of FIG. 8, and the similarities are not repeated here. The sound tube 214 of the speaker 210 can extend along the edge of the second sound box 212 and the first sound box 211, such that the overall length of the speaker 210 can be reduced.

Referring to FIG. 12, a schematic diagram of a speaker 310 according to another embodiment. In the present embodiment, the first sound box 311, the second sound box 312, and the horn 313 of the speaker 310 are similar to the first sound box 111, the second sound box 112, and the horn 113 of FIG. 8, and the similarities are not repeated here. The sound tube 314 of the speaker 310 can avoid the screw column 390 (or other elements), and extend along the edge of the screw column 390 to comply with the structural design.

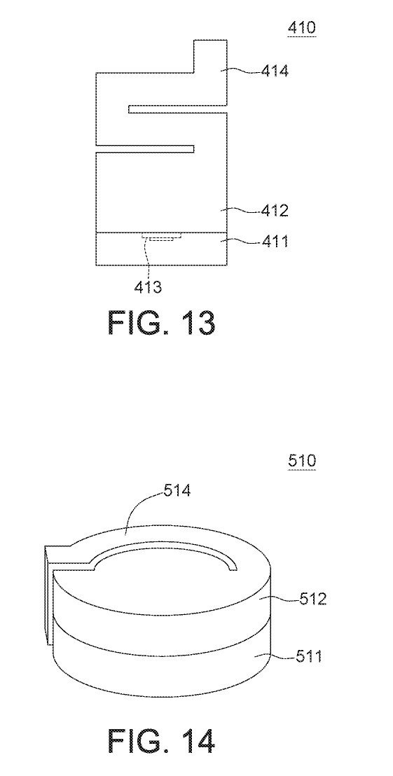

Referring to FIG. 13, a schematic diagram of a speaker 410 according to another embodiment is shown. In the present embodiment, the first sound box 411, the second sound box 412 and the sound tube 414 of the speaker 410 are stacked in order. The horn 413 is disposed at the connection between the first sound box 411 and the second sound box 412. The design of stacking the first sound box 411, the second sound box 412 and the sound tube 414 can effectively reduce the overall length of the speaker 410.

Referring to FIG. 14, a schematic diagram of a speaker 510 according to another embodiment is shown. In the present embodiment, the first sound box 511 and the second sound box 512 of the speaker 510 are not limited to cuboids or cubes, and the first sound box 511 and the second sound box 512 can be formed of circular (or elliptical) columns. The second sound box 512 is stacked on the first sound box 511. The sound tube 514 extends along the edge of the first sound box 511 and the edge of the second sound box 512, such that the speaker 510 is substantially a circular (or elliptical) column.

According to the above embodiments, when the speaker adopts a thinned or miniaturized horn, through the design of the first sound box, the second sound box and the sound tube, the low frequency sound can have very good performance when the frequency ranges from 600 Hz to 250 Hz. Therefore, the frequency of the sound can be extended to 250 Hz to satisfy the users' audio enjoyment.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A speaker, comprising:
a first sound box;
a horn disposed in the first sound box;
a second sound box, wherein the horn faces the second sound box; and
a sound tube connected to the second sound box.

2. The speaker according to claim 1, wherein a volume of the first sound box ranges from 0.8 cm³ to 1.2 cm³, and the volume of the second sound box is greater than a volume of the first sound box.

3. The speaker according to claim 1, wherein a ratio of a volume of the second sound box to a volume of the first sound box is greater than 3.75.

4. The speaker according to claim 1, wherein the first sound box is a hermetic sound box, and the second sound box is an open sound box.

5. The speaker according to claim 1, wherein the sound tube is connected to an opening of the second sound box, and the horn is disposed at a connection between the first sound box and the second sound box.

6. The speaker according to claim 1, wherein the speaker is used for providing a low frequency sound wave having a frequency which ranges from 600 Hz to 250 Hz, the sound tube has a length negatively correlated with the frequency of the low frequency sound wave, the sound tube has a cross-sectional area positively correlated with the frequency of the low frequency sound wave, and the second sound box has a volume negatively correlated with the frequency of the low frequency sound wave.

7. The speaker according to claim 1, wherein the sound tube has a uniform cross-section, and the sound tube is curved.

8. The speaker according to claim 1, wherein the horn has a vibration film disposed on an inner surface of the second sound box.

9. The speaker according to claim 1, wherein a volume of the second sound box ranges from 8 cm³ to 10 cm³, a length of the sound tube ranges from 11 cm to 13 cm, and a cross-sectional area of the sound tube ranges from 0.2 cm² to 0.4 cm².

10. The speaker according to claim 1, wherein a length of the horn ranges from 1.5 cm to 2.6 cm, a width of the horn ranges from 0.8 cm to 1.1 cm, and a thickness of the horn ranges from 0.2 cm to 0.4 cm.

11. An electronic device, comprising:
a speaker, comprising:
a first sound box;
a horn disposed in the first sound box;
a second sound box, wherein the horn faces the second sound box; and
a sound tube connected to the second sound box; and
a sound processing circuit used for providing a sound signal to the speaker.

12. The electronic device according to claim 11, wherein a volume of the first sound box ranges from 0.8 c to 1.2 cm³, and the volume of the second sound box is greater than a volume of the first sound box.

13. The electronic device according to claim 11, wherein a ratio of a volume of the second sound box to a volume of the first sound box is greater than 3.75.

14. The electronic device according to claim 11, wherein the first sound box is a hermetic sound box, and the second sound box is an open sound box.

15. The electronic device according to claim 11, wherein the sound tube is connected to an opening of the second sound box, and the horn is disposed at a connection between the first sound box and the second sound box.

16. The electronic device according to claim 11, wherein the speaker is used for providing a low frequency sound wave having a frequency which ranges from 600 Hz to 250 Hz, the sound tube has a length negatively correlated with the frequency of the low frequency sound wave, the sound tube has a cross-section positively correlated with the frequency of the low frequency sound wave, and the second sound box has a volume negatively correlated with the frequency of the low frequency sound wave.

17. The electronic device according to claim 11, wherein the sound tube has a uniform cross-section, and the sound tube is curved.

18. The electronic device according to claim 11, wherein the horn has a vibration film disposed on an inner surface of the second sound box.

19. The electronic device according to claim 11, wherein a volume of the second sound box ranges from 8 cm³ to 10 cm³, a length of the sound tube ranges from 11 cm to 13 cm, and a cross-sectional area of the sound tube ranges from 0.2 cm² 0.4 cm².

20. The electronic device according to claim 11, wherein a length of the horn ranges from 1.5 cm to 2.6 cm, a width of the horn ranges from 0.8 cm to 1.1 cm, and a thickness of the horn ranges from 0.2 cm to 0.4 cm.
